(19) United States
(12) Patent Application Publication
(10) Pub. No.: US 2023/0341085 A1
(43) Pub. Date: Oct. 26, 2023

(54) SNATCH BLOCK WITH PINCH ROD

(71) Applicant: Michael DeBurgh, Albuquerque, NM (US)

(72) Inventor: Michael DeBurgh, Albuquerque, NM (US)

(21) Appl. No.: 17/730,052

(22) Filed: Apr. 26, 2022

(51) Int. Cl. F16M 13/02; B66D 3/04; B66D 5/16

(52) U.S. Cl. CPC F16M 13/022; F16M 13/027; B66D 3/04; B66D 5/16

(57) ABSTRACT

Snatch blocks can be used for lifting loads. A cord is attached to the load and passed over the axle of a snatch block that is suspended above the ground. A person can raise the load by pulling on the cord's free end. The load will fall if the cord is simply released. The snatch block can have a pinch rod. Moving the cord to an engagement angle causes the cord to engage the pinch rod such that loosening the cord moves the pinch rod to a pinch position. At the pinch position, the pinch rod pinches the cord against the axle and prevents the cord from moving further and lowering the load. Pulling the free end of the cord moves the pinch rod from the pinch position. The load can be lowered when the pinch rod is not in the pinch position.

### FIELD OF THE INVENTION

Embodiments are related to snatch blocks, pulleys, lifting loads, and to suspending a load from snatch blocks.

### BACKGROUND

Snatch blocks are used for raising, lowering, and suspending loads. A support rope, chain, cable, etc. can be used to suspend a snatch block from a support such as a girder, rafter beam, tree branch, etc. A cord passes through the snatch block. One end of the cord is free, the other can be tied to a load. A user (e.g., person wanting to lift the load) can lift the load by pulling the free end of the cord. The load will fall if the free end of the cord is released. As such, the user may tie the free and to something convenient. The load is then suspended from the snatch block and is secured from falling.

### BRIEF SUMMARY

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure as a prelude to the more detailed description that is presented later.

One aspect of the subject matter described in this disclosure can be implemented as a system such as a snatch block. The system can include a first plate that has a first slot, a second plate that has a second slot, an axle fixedly attached to the first plate and to the second plate, a vertical axis that passes through the axle, and a pinch rod that has a first end that slides in the first slot and a second end that slides in the second slot. The axle can be configured for a cord to slide on the axle and between the first plate and the second plate, the snatch block can be configured for suspending a load from the axle, the load can be lowered by sliding the cord in a first direction on the axle, the load can be raised by sliding the cord in a second direction on the axle, the pinch rod is configured to pinch the cord against the axle when the pinch rod is at a pinch position, the cord is prevented from moving in the first direction when the pinch rod is in the pinch position, sliding the cord in the first direction and at an engagement angle relative to the vertical axis causes the cord to move the pinch rod to the pinch position, and sliding the cord in the second direction releases the cord by moving the pinch rod from the pinch position.

Another aspect of the subject matter described in this disclosure can be implemented as a method. The method can include suspending a load from an axle of a snatch block, lowering the load by sliding a cord in a first direction on the axle, raising the load by sliding the cord in a second direction on the axle, moving a pinch rod into a pinch position by sliding the cord in the first direction and at an engagement angle relative to a vertical axis, and moving the pinch rod from the pinch position by sliding the cord in the second direction, wherein the pinch rod pinches the cord against the axle when the pinch rod is at the pinch position, the cord is prevented from moving in the first direction when the pinch rod is in the pinch position, and the cord is free to slide on the axle when the pinch rod is not in the pinch position.

Yet another aspect of the subject matter described in this disclosure can be implemented as a system. The system can include a bearing means for raising and lowering a load, and a pinching means for pinching a cord against the bearing means when the pinching means is in a pinch position relative to the bearing means, wherein the load is lowered by sliding the cord in a first direction on the bearing means, the load is raised by sliding the cord in a second direction on the bearing means, the cord is prevented from moving in the first direction when the pinching means is in the pinch position, sliding the cord in the first direction and at an engagement angle relative to a vertical axis causes the cord to move the pinching means to the pinch position, and sliding the cord in the second direction releases the cord by moving the pinching means from the pinch position.

In some implementations of the methods and devices, the snatch block includes a suspension rod fixedly attached to the first plate and the second plate, wherein the suspension rod is configured for suspending the snatch block from a support. In some implementations of the methods and devices, the snatch block includes a suspension device wherein the suspension device is configured for suspending the snatch block from a support. In some implementations of the methods and devices, the snatch block includes at least one suspension hole wherein the at least one suspension hole is configured for suspending the snatch block from a support. In some implementations of the methods and devices, the snatch block includes a pulley on the axle wherein the cord slides on the axle by riding on the pulley. In some implementations of the methods and devices, the snatch block includes a bushing on the axle wherein the cord slides on the axle by riding on the bushing. In some implementations of the methods and devices, a monolithic body includes the axle, the first plate, and the second plate. In some implementations of the methods and devices, the monolithic body is a molded plastic part. In some implementations of the methods and devices, the first plate and the second plate are parallel. In some implementations of the methods and devices, the first end and the second end are configured to hold the pinch rod within the first slot and the second slot. In some implementations of the methods and devices, the pinch rod is textured. In some implementations of the methods and devices, the first plate is concave.

In some implementations of the methods and devices, the snatch block includes a suspension device that is configured for suspending the snatch block from a support. In some implementations of the methods and devices, the snatch block includes a rotating device that spins on the axle and is between the cord and the axle. The suspension device can include at least one of a suspension rod and a suspension hole. The rotating device can include at least one of a pulley and a bushing. A monolithic body can include the axle, the first plate, and the second plate. The monolithic body can be a molded plastic part. The first plate and the second plate can be parallel. The first end and the second end can be configured to hold the pinch rod within the first slot and the second slot. The pinch rod can be textured, and the first plate can be concave.

In some implementations of the methods and devices, a body of the snatch block includes the axle, a first plate, and a second plate, the axle is fixedly attached to the first plate and to the second plate, the axle is between the first plate and to the second plate, the first plate has a first slot, the second plate has a second slot, the vertical axis passes through the axle, and the pinch rod that has a first end that slides in the first slot and a second end that slides in the second slot. In some implementations of the methods and devices, the method includes using a suspension rod to suspend the snatch block from a support, wherein the suspension rod is fixedly attached to the first plate and to the second plate. In some implementations of the methods and devices, the method includes using a suspension hole in the first plate to suspend the snatch block from a support. In some implementations of the methods and devices, the body is a monolithic body.

In some implementations of the methods and devices, the system includes a suspension means for suspending the system from a support.

These and other aspects will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments such exemplary embodiments can be implemented in various devices, systems, and methods.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of embodiments and, together with the background, brief summary, and detailed description, serve to explain the principles of the present invention. The figures are not necessarily to scale.

FIG. 1A is a conceptual diagram illustrating a user using a snatch block to lift a load, according to some aspects.

FIG. 1B is a conceptual diagram illustrating the user engaging a pinch rod, according to some aspects.

FIG. 1C is a conceptual diagram illustrating the load suspended from the snatch block, according to some aspects.

FIG. 1D is a conceptual diagram illustrating the user disengaging the pinch rod, according to some aspects.

FIG. 1E is a conceptual diagram illustrating the user lowering the load, according to some aspects.

FIG. 2A is a line drawing illustrating a front view of a snatch block, according to some aspects.

FIG. 2B is a line drawing illustrating a side view of a snatch block, according to some aspects.

FIG. 3 is a line drawing illustrating a cut view of a snatch block, according to some aspects.

FIG. 4 illustrates a pinch rod, according to some aspects.

FIG. 5A illustrates a pinch rod in a pinch position and pinching a cord against an axle of a snatch block, according to some aspects.

FIG. 5B illustrates a pinch rod that is not in the pinch position, according to some aspects.

FIG. 5C illustrates a cord at an engagement angle and engaging the pinch rod, according to some aspects.

FIG. 6 is a line drawing illustrating a front view of a snatch block, according to some aspects.

FIG. 7 is a line drawing illustrating a side view of a snatch block with concave plates, according to some aspects.

FIG. 8 is a high-level flow diagram illustrating a method for using a snatch block to raise, suspend, and lower a load, according to some aspects.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

A new type of snatch block has a pinch rod that pinches a cord against an axle to thereby prevent a load from falling. Previous snatch blocks required that the cord be tied off or seized in some other manner. For example, a ratcheting device has been used that keeps the cord from backing out of a snatch block. The main issue with such snatch blocks is that they require one of the user's hands to perform whatever function is required for seizing or releasing the cord. As such, the user is often required to just one hand to hold the cord and suspend the load. The user cannot use both hands for raising and lowering the load when one hand be used to must free the cord or seize the cord. The new type of snatch block can be operated entirely with one hand, thereby leaving the other hand free for other tasks such as supporting/balancing the user, guiding the load, etc. If the load is heavy, the user can use both hands, instead of just one, to hold the cord and thereby raise or lower the load.

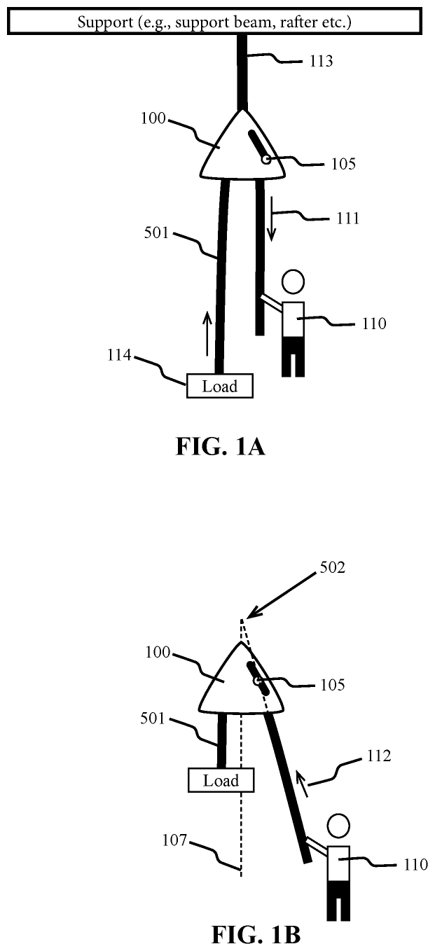

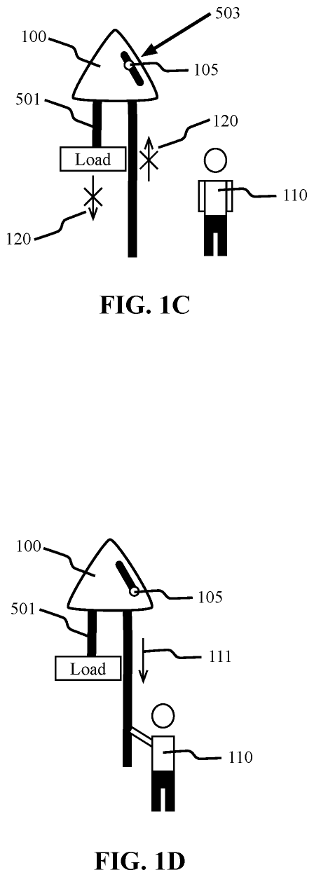

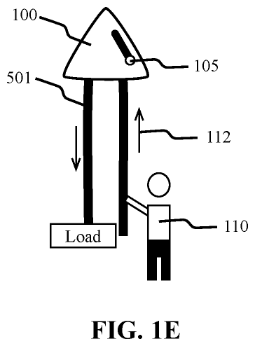

FIGS. 1A-1E illustrate a user 110 using a snatch block 100 to raise, suspend, and lower a load 114. FIG. 1A is a conceptual diagram illustrating a user 110 using a snatch block 100 to lift a load 114, according to some aspects. The snatch block 100 is suspended from a support by a support rope 113. A cord 501 passes through the snatch block 100. In fact, the cord passes between the first plate and the second plate of the snatch block 100 and over an axle of the snatch block 100. The load end of the cord 501 is attached to a load 114. The free end of the cord 501 is held by the user 110. The user 110 is pulling the cord 501 to thereby raise the load. The load is lowered when the cord 501 moves through the snatch block in a first direction. In FIG. 1A, the cord 501 is moving through the snatch block in a second direction 111 because the free end is being pulled by the user 110 and the load 114 is thereby raised. The snatch block's pinch rod 105 is in its lowest position.

FIG. 1B is a conceptual diagram illustrating the user engaging a pinch rod 105, according to some aspects. The user 110 has moved the cord 501 into a position where the cord 501 engages the pinch rod 105. The user has also loosened the cord 501 such that the cord 501 moves the pinch rod 105 into a pinch position. When loosened by the user 110, the cord 501 begins moving in the first direction 112. When the cord 501 moves the pinch rod into the pinch position, it is prevented from moving further in the second direction because the pinch rod 105 is in the pinch position. The pinch position is a position at which the pinch rod 105 is pinching the cord 501 against the axle of the snatch block 100 and preventing the cord from further motion in the second direction. The cord 501 engages the pinch rod 105 when the free end of the cord 501 is held at an engagement angle 502 relative to a vertical axis 107 passing through the snatch block 100. The cord 501 may move freely through the snatch block when the angle between the free end and the vertical axis 107 is less than the engagement angle.

FIG. 1C is a conceptual diagram illustrating the load suspended from the snatch block 100, according to some aspects. In FIG. 1C, the user 110 has released the free end of the cord 501. The pinch rod 105 is in the pinch position and prevents the cord 501 from moving through the snatch block in the first direction 112. As such, the load is suspended from the snatch block. The crossed-out arrows 120 indicate that the cord 501 cannot move in the first direction 112. The support rope and the entirety of the cord between the load and the snatch block are parallel to the vertical axis because the load is suspended directly from the snatch block and the snatch block is suspended via the support rope 113.

FIG. 1D is a conceptual diagram illustrating the user 110 disengaging the pinch rod 105, according to some aspects. The user 110 pulls the cord 501 in the second direction 111 which moves the pinch rod 105 out of the pinch position. The pinch rod 105 may then fall to the bottom of the slots in the snatch block 100.

FIG. 1E is a conceptual diagram illustrating the user 110 lowering the load, according to some aspects. The pinch rod 105 is not in the pinch position. As such, the cord 501 is free to move in the first direction 112. The user therefore uses the cord 501 to lower the load.

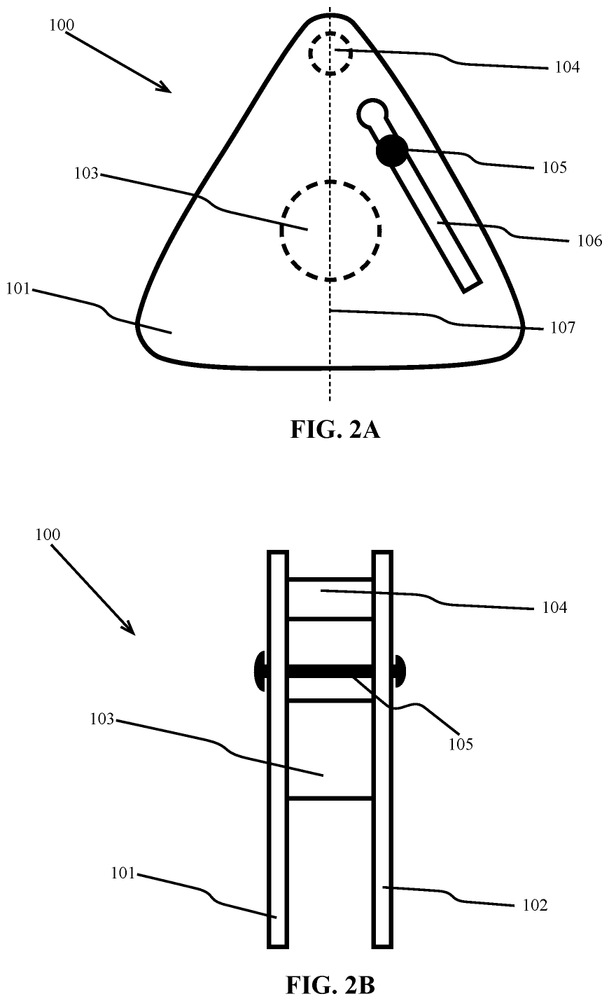

FIG. 2A is a line drawing illustrating a front view of a snatch block 100, according to some aspects. The first plate 101 has a first slot 105. The first end of the pinch rod 105 can slide in the first slot. The snatch block's axle 103 is attached to the first plate 101 and to the second plate which is behind the first plate 101. The snatch block 100 can have a suspension device that can be used for suspending the snatch block from a support. For example, the suspension device can be a suspension rod 104 attached to the first plate 101 and to the second plate. The support rope 113 illustrated in FIG. 1A can be tied to the suspension rod 104. The vertical axis 107 of the snatch block is an axis that passes through the axle 103 and the suspension device. The vertical axis 107 shown in FIG. 2A can be seen to pass through the center of the axle 103 and the center of the suspension rod 104.

FIG. 2B is a line drawing illustrating a side view of a snatch block 100, according to some aspects. The body of the snatch block includes the axle 103, the first plate 101, and the second plate 102. The axle 103 is between the first plate 101 and the second plate 102. The axle can be fixedly attached to the first plate 101 and the second plate 102 via adhesives, solder, welding, fasteners (e.g., machine screws, etc.), or some other technique. Techniques such as welding may result in a snatch block body that is a monolithic body. A monolithic body of a snatch block may be produced via a molding process. For example, the body may be molded as a single piece of material such as plastic, metal, or some other moldable material. The body can include the suspension device. As such, the suspension rod may be part of the monolithic body of the snatch block 100. The first plate 101 has a first slot 106. The second plate can be identical to the first plate. As such, the second plate can have a second slot. In FIG. 2B the first plate 101 and the second plate 10 are parallel. The pinch rod 105 passes through the first slot 106 and the second slot.

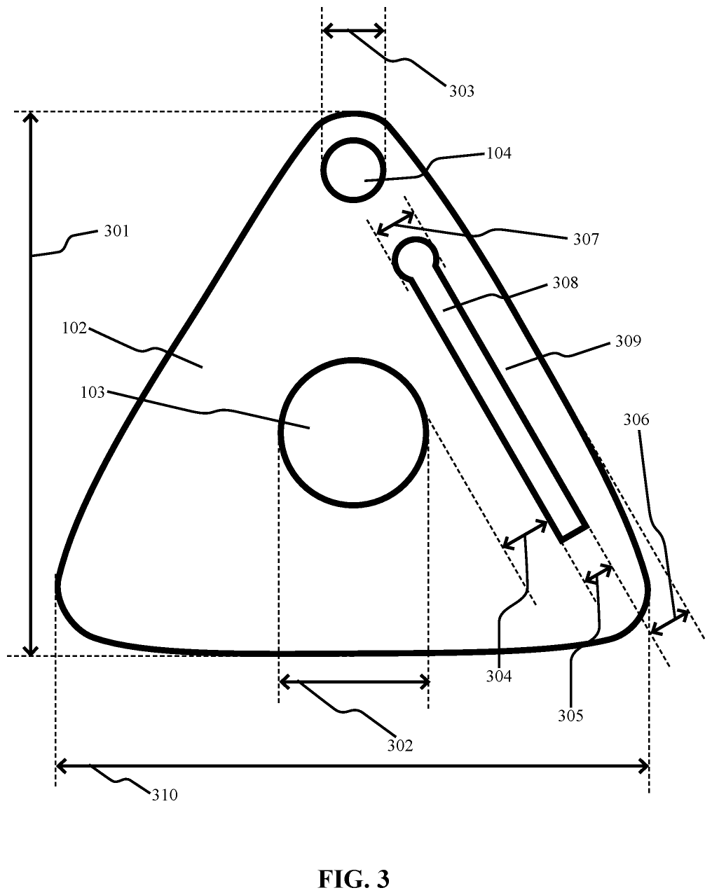

FIG. 3 is a line drawing illustrating a cut view of a snatch block 100, according to some aspects. The second plate 102, which was behind the first plate 101 in FIG. 2A, can now be seen. The second plate 102 has a second slot 308. The axle 103 has an axle diameter 302. The suspension rod 104 has a suspension rod diameter 303. The snatch block 100 has a height 301 and a side length 310. The second slot, which may be identical to the first slot, may be keyhole shaped with a straight section and a rounded section. The slots may alternatively consist only of one or more straight section or of some other geometry. The straight section of the second slot has a slot width 305. The rounded section of the second slot has a keyhole width 307. The second plate bar 309 is the area of the second plate 102 between the second slot 308 and the nearest edge of the second plate 102. The second plate bar has a second plate bar width 306. The first plate 101 may have a substantially similar first plate bar. The distance from the slot 308 to the axle 103 establishes the minimum cord diameter 304. A cord smaller than the minimum cord diameter cannot be pinched against the axle.

When the pinch rod 105 is pinching the cord 501, force is applied to the pinch rod 105. The pinch rod 105 pushes out against the first plate bar and the second plate bar 309. The material selection and dimensions of the pinch rod 105, first plate bar, and second plate bar 309 may therefore be determinative of the load bearing capability of the snatch block. The most successful prototype to date, which is designed for lifting and holding greenhouse lights, has a first plate and a second plate that are 2.25 mm thick brass. The prototype has a second plate bar width 306 and first plate bar width of 2 mm, a 6.35 mm keyhole width, and a 4.9 mm slot width. The prototype axle has a 12.25 axle diameter and a 4.7 mm suspension rod diameter. The prototype has a 38 mm side length. The first plate 101 and the second plate 102 of the prototype are similar in appearance (rounded corner equilateral triangles) to those illustrated in the figures.

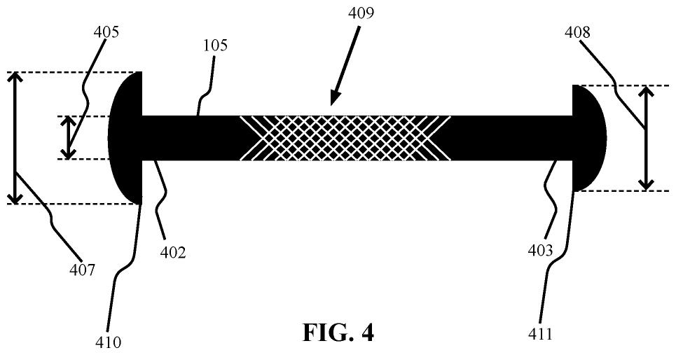

FIG. 4 illustrates a pinch rod 105, according to some aspects. The pinch rod 105 has a first end 402 and a second end 403. The first end 402 can slide in the first slot 106 and the second end 403 can slide in the second slot 308. The pinch rod 105 can be textured. For example, FIG. 4 illustrates a cross hatch pattern as the texture 409 of the pinch rod 105. The texture 409 helps the cord 501 engage the pinch rod 105 and move the pinch rod into the pinch position 503.

The pinch rod 105 has wide ends. The first end 402 has a first wide end 410 that has a first end diameter 407. The second end 403 has a second wide end 411 that has a second end diameter 408. The pinch rod itself has a pinch rod diameter 405. The prototype discussed above has a 3.7 mm pinch rod diameter 405, a 6.7 mm first end diameter 407, and a 6.2 mm second end diameter 408. The second end diameter 408 is smaller than the keyhole width 307 and larger than the slot width 305. The first end diameter 407 is larger than the keyhole width 307. As such, the wide ends hold the pinch rod in the first slot and the second slot. Furthermore, the first end, being larger than the keyhole width, prevents the pinch rod from passing completely through the round sections of the slots. The second end, being smaller than the keyhole width 307, allows the pinch rod to be placed in the slots.

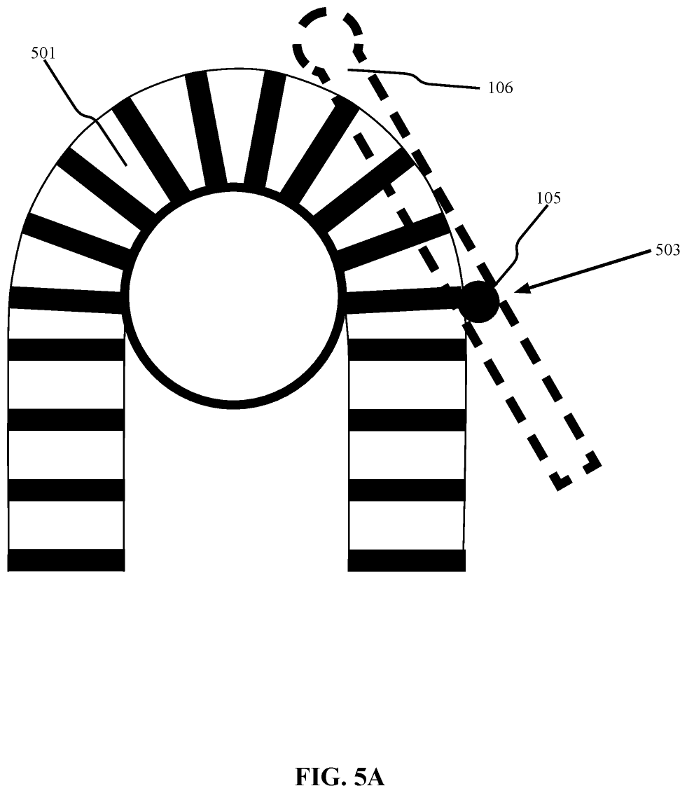

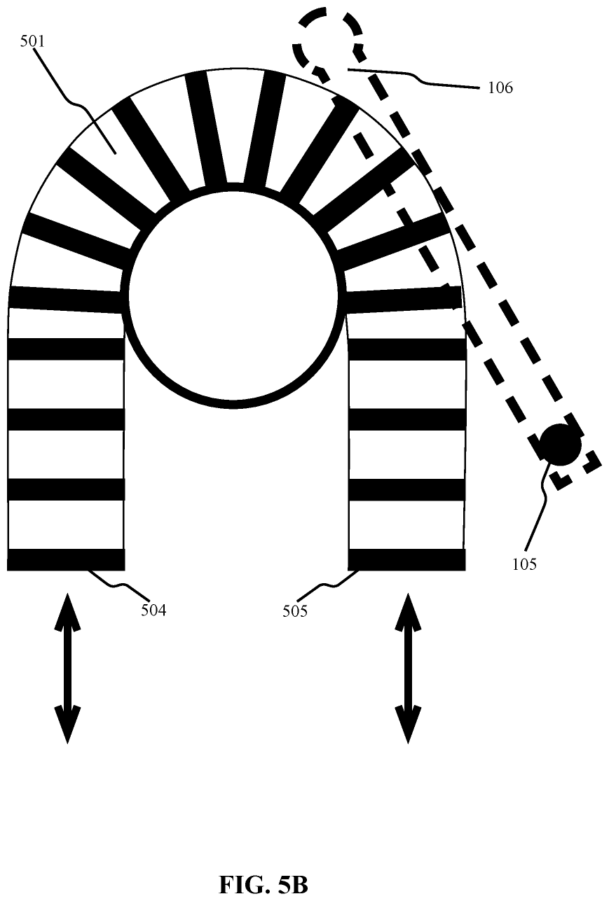

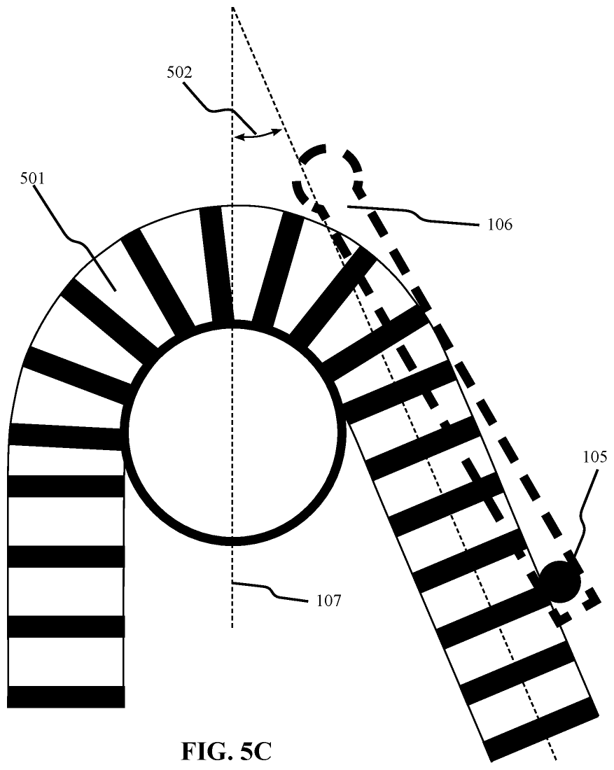

FIG. 5A illustrates a pinch rod 105 in a pinch position 503 and pinching a cord 501 against an axle of a snatch block, according to some aspects. The cord cannot slide on the axle in the first direction 112 because the cord 501 is held fast. The cord 501 is held fast because the pinch rod 105 is pinching the cord 501 against the axle 103. The cord 501 has a diameter in excess of the minimum cord diameter 304. The precise location of the pinch position 503 can be different for cords having different diameters.

FIG. 5B illustrates a pinch rod 105 that is not in the pinch position 503, according to some aspects. The cord is free to slide on the axle 103 in the first direction 112 or the second direction 111. The cord is free to slide on the axle 103 because the pinch rod 105 is not in the pinch position. The load end 504 of the cord 501 is the end to which the load is attached. The free end 505 of the cord is the end that the user can pull to lift the load or loosen to lower the load.

FIG. 5C illustrates a cord 501 at an engagement angle 502 and engaging the pinch rod 105, according to some aspects. The free end 505 of the cord 501 can be moved away from the vertical axis 107. The cord engages the pinch rod 105 when the angle between the vertical axis 107 and the free end 505 of the cord 501 reaches the engagement angle 502. Moving the free end 505 even further from the vertical axis 107 can engage the pinch rod 105 more firmly. Allowing the cord 501 to move in the first direction 112 causes the cord 501 to move the pinch rod 105 into the pinch position 503.

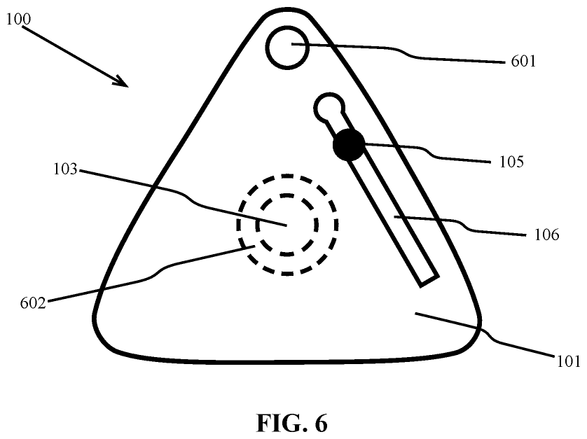

FIG. 6 is a line drawing illustrating a front view of a snatch block, according to some aspects. The suspension device of the snatch block 100 illustrated in FIG. 6 is a suspension hole 601. The support rope 113 illustrated in FIG. 1A can be passed through the suspension hole 601 and then tied to the snatch block 100. The snatch block can have a rotating device 602 (e.g., pulley, bushing, bearing, etc.) on the axle. The rotating device can spin on the axle and is between the cord 501 and the axle 103. The cord 501 may therefore slide on the axle by spinning the rotating device or by sliding on the rotating device.

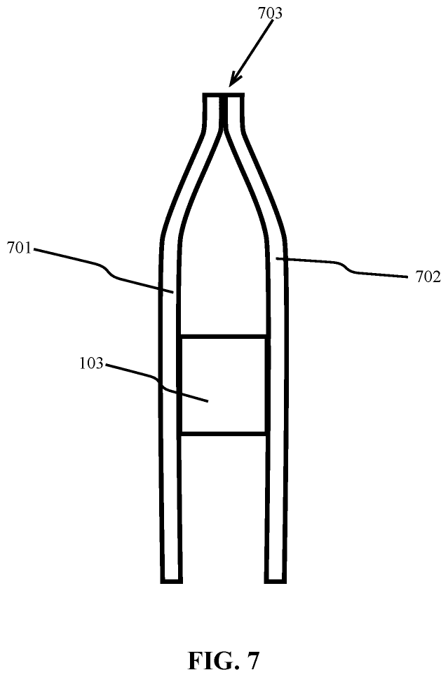

FIG. 7 is a line drawing illustrating a side view of a snatch block with concave plates, according to some aspects. The first plate 701 and the second plate are concave such that they can meet at a plate junction 703. In FIG. 7, both plates are concave and are equally curved such that the plate junction 703 is centered in the snatch block. Such centering may be required to avoid off center loading that may cause the snatch block to tip under load. Some applications may allow for off center loading such that one plate is curved more than the other (e.g., one plate may be flat). The support rope 113 may pass between the plates in the space between the plate junction 703 and the axle 103. In such a scenario, the suspension device is the plate junction. Alternatively, a suspension hole, such as suspension hole 601, in the plate junction may be the suspension device.

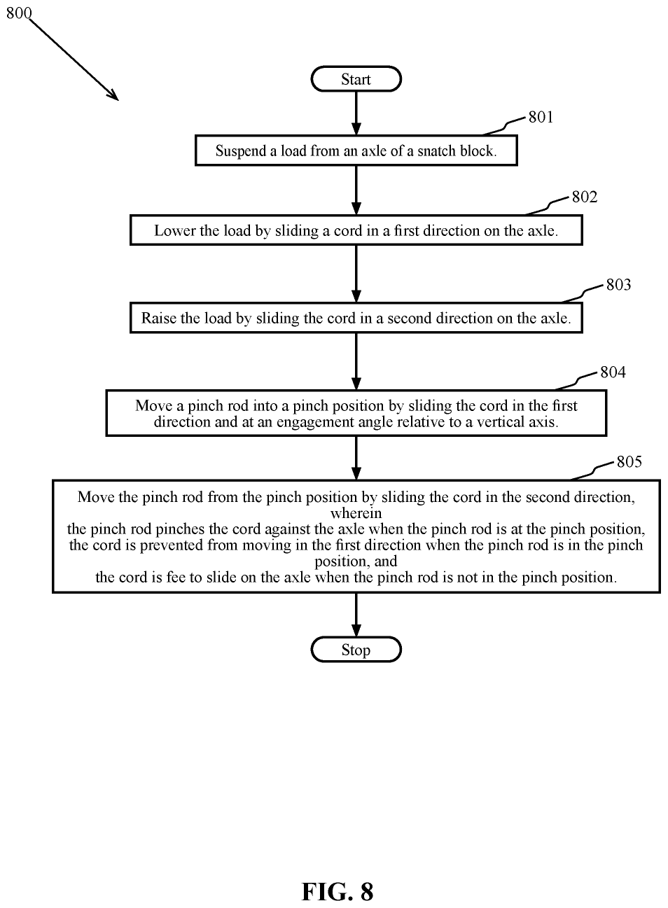

FIG. 8 is a high-level flow diagram illustrating a method for using a snatch block to raise, suspend, and lower a load, according to some aspects. After starting, at block 801 a load can be suspended from an axle of a snatch block. At block 802, the load can be lowered by sliding a cord in a first direction on the axle. At block 803, the load can be raised by sliding the cord in a second direction on the axle. At block 804, a pinch rod can be moved into a pinch position by sliding the cord in the first direction and at an engagement angle relative to a vertical axis. At block 805, the pinch rod can be moved from the pinch position by sliding the cord in the second direction, wherein the pinch rod pinches the cord against the axle when the pinch rod is at the pinch position, the cord is prevented from moving in the first direction when the pinch rod is in the pinch position, and the cord is free to slide on the axle when the pinch rod is not in the pinch position.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A snatch block comprising:
a first plate that has a first slot;
a second plate that has a second slot;
an axle fixedly attached to the first plate and to the second plate;
a vertical axis that passes through the axle; and
a pinch rod that has a first end that slides in the first slot and a second end that slides in the second slot,
wherein
the axle is configured for a cord to slide on the axle and between the first plate and the second plate,
the snatch block is configured for suspending a load from the axle,
the load is lowered by sliding the cord in a first direction on the axle,
the load is raised by sliding the cord in a second direction on the axle,
the pinch rod is configured to pinch the cord against the axle when the pinch rod is at a pinch position,
the cord is prevented from moving in the first direction when the pinch rod is in the pinch position,
sliding the cord in the first direction and at an engagement angle relative to the vertical axis causes the cord to move the pinch rod to the pinch position, and
sliding the cord in the second direction releases the cord by moving the pinch rod from the pinch position.

2. The snatch block of claim 1, further including a suspension rod fixedly attached to the first plate and the second plate, wherein the suspension rod is configured for suspending the snatch block from a support.

3. The snatch block of claim 1, further including further including a suspension device wherein the suspension device is configured for suspending the snatch block from a support.

4. The snatch block of claim 1, further including further including at least one suspension hole wherein the at least one suspension hole is configured for suspending the snatch block from a support.

5. The snatch block of claim 1, further including a pulley on the axle wherein the cord slides on the axle by riding on the pulley.

6. The snatch block of claim 1, further including a bushing on the axle wherein the cord slides on the axle by riding on the bushing.

7. The snatch block of claim 1, wherein a monolithic body includes the axle, the first plate, and the second plate.

8. The snatch block of claim 7, wherein the monolithic body is a molded plastic part.

9. The snatch block of claim 1, wherein the first plate and the second plate are parallel.

10. The snatch block of claim 1, wherein the first end and the second end are configured to hold the pinch rod within the first slot and the second slot.

11. The snatch block of claim 1, wherein the pinch rod is textured.

12. The snatch block of claim 1, wherein the first plate is concave.

13. The snatch block of claim 1, further including:
a suspension device that is configured for suspending the snatch block from a support; and
a rotating device that spins on the axle and is between the cord and the axle;
wherein
the suspension device includes at least one of a suspension rod and a suspension hole,
the rotating device includes at least one of a pulley and a bushing,
a monolithic body includes the axle, the first plate, and the second plate,
the monolithic body is a molded plastic part,
the first plate and the second plate are parallel,
the first end and the second end are configured to hold the pinch rod within the first slot and the second slot,
the pinch rod is textured, and
the first plate is concave.

14. A method comprising:
suspending a load from an axle of a snatch block;
lowering the load by sliding a cord in a first direction on the axle;
raising the load by sliding the cord in a second direction on the axle;
moving a pinch rod into a pinch position by sliding the cord in the first direction and at an engagement angle relative to a vertical axis; and
moving the pinch rod from the pinch position by sliding the cord in the second direction,
wherein
the pinch rod pinches the cord against the axle when the pinch rod is at the pinch position,
the cord is prevented from moving in the first direction when the pinch rod is in the pinch position, and
the cord is free to slide on the axle when the pinch rod is not in the pinch position.

15. The method of claim 14 wherein:
a body of the snatch block includes the axle, a first plate, and a second plate;
the axle is fixedly attached to the first plate and to the second plate;
the axle is between the first plate and to the second plate;
the first plate has a first slot;
the second plate has a second slot;
the vertical axis passes through the axle; and
the pinch rod that has a first end that slides in the first slot and a second end that slides in the second slot.

16. The method of claim 15, further including:
using a suspension rod to suspend the snatch block from a support,
wherein the suspension rod is fixedly attached to the first plate and to the second plate.

17. The method of claim 15, further including:
using a suspension hole in the first plate to suspend the snatch block from a support.

18. The method of claim 15, wherein the body is a monolithic body.

19. A system comprising:
a bearing means for raising and lowering a load; and
a pinching means for pinching a cord against the bearing means when the pinching means is in a pinch position relative to the bearing means;
wherein
the load is lowered by sliding the cord in a first direction on the bearing means,
the load is raised by sliding the cord in a second direction on the bearing means,
the cord is prevented from moving in the first direction when the pinching means is in the pinch position,
sliding the cord in the first direction and at an engagement angle relative to a vertical axis causes the cord to move the pinching means to the pinch position, and
sliding the cord in the second direction releases the cord by moving the pinching means from the pinch position.

20. The system of claim 19, further including a suspension means for suspending the system from a support.
